(19) United States
(12) Patent Application Publication
(10) Pub. No.: US 2015/0093007 A1
(43) Pub. Date: Apr. 2, 2015

(54) SYSTEM AND METHOD FOR THE CLASSIFICATION OF MEASURABLE LESIONS IN IMAGES OF THE CHEST

(71) Applicants: Hubert Beaumont, Roquefort les pins (FR); Estanislao Oubel, Antibes (FR)

(72) Inventors: Hubert Beaumont, Roquefort les pins (FR); Estanislao Oubel, Antibes (FR)

(73) Assignee: MEDIAN TECHNOLOGIES, vALBONNE (FR)

(21) Appl. No.: 14/503,396

(22) Filed: Sep. 30, 2014

Related U.S. Application Data
(60) Provisional application No. 61/884,194, filed on Sep. 30, 2013.

(51) Int. Cl. G06T 7/00; G06F 19/00

(52) U.S. Cl. CPC G06T 7/0014; G06F 19/34; G06T 2207/10081
USPC 382/131

(57) ABSTRACT

A system and method for the automated classification of lesions in CT images of the chest between measurable and non-measurable lesions is disclosed. The method comprises the steps of identifying lesions in a CT image, performing repeated measurements of selected metrics on the identified lesions and selecting as measurable lesions those with a variability of less than a pre-defined limit of agreement. Then a training step is carried out relying on a variety of image related features extracted from the lesions. Finally, labeling of lesions according to their likelihood of being consistently measured is performed.

### TECHNICAL FIELD

The disclosed methods relate to the automated classification of pulmonary lesions in computed tomography images. More specifically, the method relates to the identification of measurable lesions which can be followed over time and operate as imaging biomarkers of progression of disease.

### BACKGROUND

Longest Axial Diameter (LAD) of tumors is one the main imaging biomarker in oncology. Several studies have pointed out limitations of the Response Evaluation Criteria in Solid Tumor (RECIST) associated to LAD. One limitation is the selection of target lesions that RECIST restricts to “Measurable” lesions (ML). So far, no precise definition of measurability is available despite its impact on inter-readers (IR) variability and sensitivity of the response.

At baseline, tumor lesions/lymph nodes will be categorized as measurable or non-measurable as follows: Measurable Lesions: Must be accurately measured in at least one dimension (longest diameter in the plane of measurement is to be recorded) with a minimum size of:
10 mm by CT scan (CT scan slice thickness no greater than 5 mm).
10 mm caliper measurement by clinical exam (lesions which cannot be accurately measured with calipers should be recorded as non-measurable).
20 mm by chest X-ray
   Are considered non-measurable are all other lesions, including small lesions (longest diameter <10 mm) as well as truly non-measurable lesions. Lesions considered truly non-measurable include: leptomeningeal disease, ascites, pleural or pericardial effusion, inflammatory, breast disease, lymphangitic involvement of skin or lung, abdominal masses/abdominal organomegaly identified by physical exam that is not measurable by reproducible imaging techniques.

Characterization of lesions based on morphological and intensity related features has been attempted. Characteristics include shape related features including spiculation or regular, sphericity or ellipticity, elongation, cavitation, diffusion, calcification, uniformity, location features including contiguous to the pleura, attached to the mediastinum, attached to intestinal organ, in the bronchi, near vessels . . . The main problem with such characterization is that the features are often subjective and different readers will classify lesions differently.

There is therefore a need for methods to improve the identification of measurable pulmonary lesions using objective image-based features.

### SUMMARY

a) The specification discloses a computer-implemented system and method for characterizing lesions as measurable on non-measurable without any reliance on subjective lesion features. The method comprises: identifying pulmonary lesions of interest (LOIs) in a tomographic image of the chest; performing repeated measurements of a plurality of metrics in the identified LOIs; computing the variability of the repeated measurements; applying a threshold to the variability of the repeated measurements wherein the threshold is derived from a population of reference and wherein the LOIs with measurements having a variability greater than the threshold are classified as non-measurable lesions (NML); extracting a plurality of image-based features from each LOI; correlating the variability of the repeated measurements with the plurality of imager-based features; and labelling the LOIs according to their likelihood of being consistently measured.

### DEFINITIONS

BIOMARKER means a distinct biochemical, genetic, or molecular characteristic or substance that is an indicator of a particular biological condition or process.

IMAGING BIOMARKER means a biologic feature detectable by an imaging modality such as CT, MRI or ultrasound . . . and a metric associated with that feature.

RELIABILITY means how consistently a measurement of skill or knowledge yields similar results under varying conditions. If a measure has high reliability, it yields consistent results.

IMAGING FEATURE EXTRACTION Turn images or limited region of images into numerical features usable for machine learning

IMAGE TEXTURE is a set of metrics calculated in image processing designed to quantify the perceived texture of an image. Image Texture gives us information about the spatial arrangement of color or intensities in an image or selected region of an image.

### FIGURES AND DRAWINGS

FIG. 1 is a general block diagram of the disclosure for identification and the prediction of non-measurable lesions.

FIG. 2 is Bland-Altman display of manual segmentations of two operators. Dashed blue lines represent the Limit of Agreement (LoA) of these measures.

FIG. 3 Output of the method able to label lesions according to their likelihood of being consistently measured.

### DETAILED DESCRIPTION

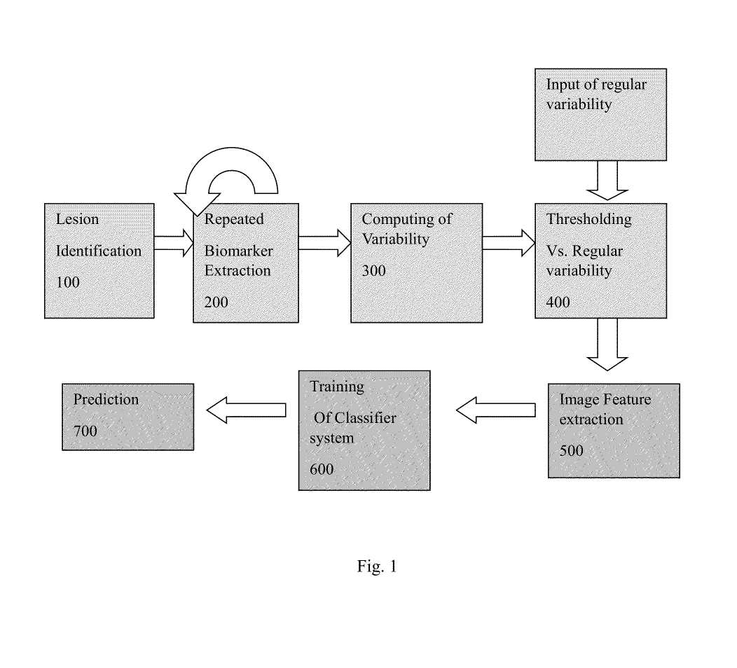

A block diagram of the system and method of the disclosure is illustrated in FIG. 1.

Module 100 is the lesion identification module consisting in selecting a significant number of Lesions of Interest (LOIs) in the image being analyzed. The data set is designed to be representative to the context within the reliability of the biomarker will be applicable. It is key that the dataset will be representative of the full range of the illness, of the severity of the disease and of the imaging where the biomarker is applicable and will be used.

Module 200 is the module corresponding to the biomarker extraction. This module consists in performing repeated measurements of the metrics of interest likely to be affected by variability (for instance lesion size, lesion mean intensity or lesion texture derived metrics). A significant number of repetitions must be performed in order to reliably assess the range of the variability and to be able to draw a probability for a lesion to go beyond the threshold of the regular variability used in module 400. Biomarker extraction can rely on automated segmentation, semi-automated segmentation processing with manual adjustments or manual measurements such as the long axis diameter (LAD) in the context of the Response Evaluation Criteria in Solid Tumors (RECIST) assessments. In another embodiment the method of the disclosure performs semi-automatic segmentation without any correction in order to consider the measurability properties of lesions as a whole as a function of both algorithm and lesions features.

Module 300 performs the computation of descriptive statistics. This module computes the variability of the measures relying on a given statistic including the standard deviation or Limit of Agreement (LoA) from a Bland-Altman analysis. This module can generate the distribution of the repeated measurements, the parameters of this distribution, limits of validity for these assessments, limits of linearity.

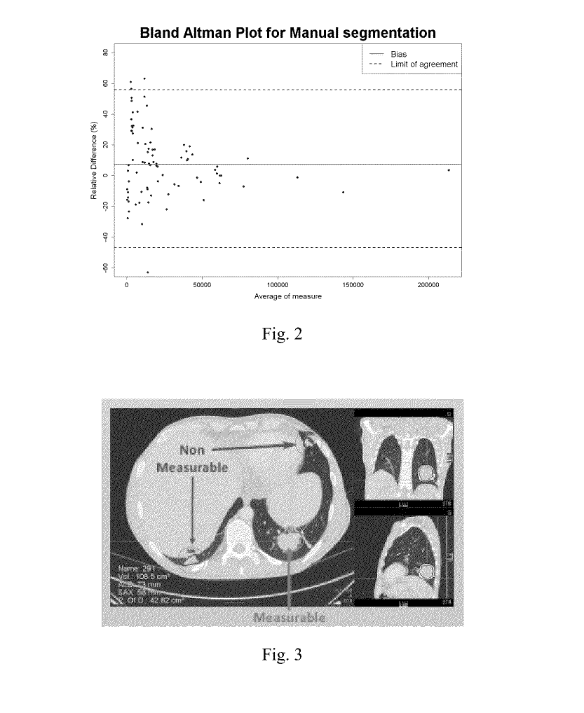

Module 400 computes the Gold Standard for the measurability of lesions. This module labels every selected lesion as a Measurable Lesion (ML) or a Non-Measurable Lesion (NML). This module applies a threshold to the variability of the repeated measurements performed on each lesion. The threshold function separates lesions in two groups according to their likelihood of repeatability. In an embodiment, the value of the threshold is computed from a confirmed population of reference featuring variability classified as “regular” or acceptable. A preferred embodiment of the method comprises repeating measurements twice at Module 200 and considering statistics comprising a Limit of Agreement at Module 300 with a given value of regular variability that is an input of the method. In an embodiment illustrated in FIG. 2, measurements having a variability higher than the LoA are classified as Non-measurable lesions. Another embodiment of the method consists in repeating measurements a significant number of times at Module 200 and considering statistics as Standard Deviation of measurements at Module 300 with a given value of a regular variability that is an input of the method. Then, this embodiment consider as non-measurable lesions where a proportion P of repetition exceed two time the Standard Deviation of the regular variability. According to this embodiment, P can be understood as the probability of being non-measurable.

Module 500 is the feature extraction module. This step comprises extracting a plurality of image-based features or mixing clinical and patient information. In a preferred embodiment, image-based features comprise geometric features and intensity features derived from lesion segmentation. Geometric features comprise volume, roundness, convexity index, genius number. Intensity features are derived from techniques comprised of histogram analysis, number of modes, standard deviation, inter-quartile distances, skewness. In still another preferred embodiment, second order statistics or textural features are extracted. In a preferred embodiment, feature extraction is semi-automatic. In another preferred embodiment, feature extraction is automatic.

Module 600 comprises a classification training step. Input of the classification comprises the Gold Standard output from Module 400 for each lesion and the feature computed from each of these lesions. This step consists in correlating the probability of the repeatability of the lesions with the features computed from their segmentations. Training of classification can be carried out relying on simple rules or taking benefits of advanced system or neural network such as Linear Discriminant Analysis (LDA) or Support Vector Machine (SVM). Performance of the system can be tuned according to the wished balance between Sensitivity and Specificity or according of the Area Under the Curve (AUC) within a given range of the operating curve.

Module 700 is the prediction step. Input of the detection is the output of Module 500 where image-based feature of the lesions are extracted and a set of parameters output from the training step of classification of Module 600. All features and information are input to a simple rules scheme or are input for an advanced system or neural network such as Linear Discriminant Analysis (LDA) or Support Vector Machine (SVM). According to FIG. 3, output of Module 700 is the labeling of lesions according to their likelihood of being consistently measured.

### EXAMPLE

We based our study on published results reporting that IR Limit of Agreement (LoA) of LAD assessment is +/−15%. Our data consisted in Training (Tr) and Testing (Te) sets of respectively 99 and 100 lesions evaluated twice. Four readers performed LAD measurements: two experienced imaging scientists (IS) and two expert radiologists (ER). ISs reported 14 subjective binary features, as phenotypes and location, from a subset of 129 lesions randomly drawn from Tr and Te. All lesions were labelled as “Non Measurable” (NML) when the difference of repeated measurements exceeded the LoA. 79 image-derived features such as statistics of intensities and morphology were automatically extracted from all measurements. Sensitivity (Se) and Specificity (Sp) in detecting ML have been computed with a Support Vector Machine (SVM) relying on either subjective or automatic lesions features.

Results

Tr and Te sets included respectively 22.3% and 27.0% of NML. We found a Kappa value of 0.26 [0.18; 0.37] when evaluating the IR agreement in assessing the subjective features of lesions. Classification based on subjective features of lesion was unable to discriminate NML. Performance of detection using automatic feature computing applied to testing set was Se=90.5%; Sp=49.6%.

Conclusion

A relevant proportion of NML affected the datasets. Subjective assessment of features is not reproducible and has a poor discriminative power, making subjective ML identification problematic. Computing and classifying features allowed ruling out a significant proportion of NML making computer aided processing an opportunity to improve RECIST.

We claim:

1. A computer-implemented method for the automated classification of lesions in tomographic images of the chest between measurable and non-measurable lesions comprising
a) identifying pulmonary lesions of interest (LOIs) in a tomographic image of the chest;
b) performing repeated measurements of a plurality of metrics in the identified LOIs;
c) computing the variability of the repeated measurements;
d) applying a threshold to the variability of the repeated measurements wherein the threshold is derived from a population of reference and wherein the LOIs with measurements having a variability greater than the threshold are classified as non-measurable lesions (NML);
e) extracting a plurality of image-based features from each LOI;
f) correlating the variability of the repeated measurements with the plurality of imager-based features; and
g) labelling the LOIs according to their likelihood of being consistently measured.

2. The method of claim 1 wherein the identification of pulmonary LOIs

3. The method of claim 1 wherein the plurality of image-based features are selected from first, second or higher order statistical attributes of the LOIs.

4. The method of claim 1 wherein the variability is computed from a Bland-Altman analysis.

5. The method of claim 4 wherein the threshold is the limit of agreement.

6. A non-transitory computer readable medium storing a program causing a computer to execute an image process for the automated classification of lesions in tomographic images of the chest between measurable and non-measurable lesions comprising
a) identifying pulmonary lesions of interest (LOIs) in a tomographic image of the chest;
b) performing repeated measurements of a plurality of metrics in the identified LOIs;
c) computing the variability of the repeated measurements;
d) applying a threshold to the variability of the repeated measurements wherein the threshold is derived from a population of reference and wherein the LOIs with measurements having a variability greater than the threshold are classified as non-measurable lesions (NML);
e) extracting a plurality of image-based features from each LOI;
f) correlating the variability of the repeated measurements with the plurality of imager-based features; and
g) labelling the LOIs according to their likelihood of being consistently measured.

7. The non-transitory computer readable medium of claim 6 wherein the identification of pulmonary LOIs

8. The non-transitory computer readable medium of claim 6 wherein the plurality of image-based features are selected from first, second or higher order statistical attributes of the LOIs.

9. The non-transitory computer readable medium of claim 6 wherein the variability is computed from a Bland-Altman analysis.

10. The non-transitory computer readable medium of claim 9 wherein the threshold is the limit of agreement.

11. An image processing system configured for the automated classification of lesions in tomographic images of the chest between measurable and non-measurable lesions comprising
a) an identification module for lesions of interest (LOIs) extracted from a tomographic image of the chest;
b) a biomarker extraction module for performing repeated measurements of a plurality of metrics in the identified LOIs;
c) a processing module computing the variability of the repeated measurements;
d) a classification module applying a threshold to the variability of the repeated measurements wherein the threshold is derived from a population of reference and wherein the LOIs with measurements having a variability greater than the threshold are classified as non-measurable lesions (NML);
e) extracting a plurality of image-based features from each LOI;
f) correlating the variability of the repeated measurements with the plurality of image-based features; and
g) labelling the LOIs according to their likelihood of being consistently measured.
